(19) United States
(12) Patent Application Publication
(10) Pub. No.: US 2022/0038507 A1
(43) Pub. Date: Feb. 3, 2022

(54) METHODS, APPARATUSES AND SYSTEMS FOR NEGOTIATING DIGITAL STANDARDS AND COMPLIANCE

(71) Applicant: Guard Dog Solutions Inc., Salt Lake City, UT (US)

(72) Inventors: Peter Bookman, Eden, UT (US); Anant Asthana, Cottonwood Heights, UT (US)

(73) Assignee: Guard Dog Solutions Inc., Salt Lake City, UT (US)

(21) Appl. No.: 16/942,753

(22) Filed: Jul. 29, 2020

(51) Int. Cl. H04L 29/06; G06F 21/51; G06F 21/54; G06F 21/57

(52) U.S. Cl. CPC H04L 63/205; G06F 21/577; G06F 21/54; G06F 21/51

(57) ABSTRACT

Apparatuses, methods and systems for negotiating digital security standards and compliance between associated computing devices of a distributive security operation center (dSOC) and a personal security operation center (pSOC). Commonly, an enterprise/dSOC has the need of the services of a third-party/employee/pSOC to meet the business needs of the enterprise. The business needs of the enterprise often require electronic access by the third-party/employee/pSOC to confidential, private or sensitive information or data possessed by the enterprise. Onloading the third-party/employee/pSOC to the enterprise's electronic business operations required ensuring that the devices used by the third-party/employee/pSOC digital security capabilities which comply with the enterprise's digital security standards. The present invention provided apparatuses, methods and systems to ensure that the digital security capabilities of the third-party/employee/pSOC meet the technical functionality of the digital security standards of the enterprise. dSOC.

### BACKGROUND OF THE INVENTION

### 1. Field of the Invention

This invention is directed to methods, apparatuses and systems for negotiating digital standards and compliance. In particular, some implementations of the present invention relate to assisting two federated digital players to identify security standards and facilitate compliance.

### 2. Background and Related Art

Cyber threats to business assets and government regulation of certain business and privacy data require digital security policies, procedures, protocols and compliance at an expanding rate. In our digitally connected world, the number of endpoints multiples across all sectors of the economy such as banking, insurance, investment, credit card, retail, food and beverage, industrial, energy, oil/gas, automotive, transportation and utilities. Business organizations are responsible for maintaining local, regional and national infrastructures including transportation systems, power plants and transmission systems, durable goods and food manufacturing and processing and distribution facilities. In this ever-growing environment of remote business operations and the need for digital security between a personal security operations center (pSOC) and a distributive or enterprise security operations center (dSOC), the need to prevent security breaches is paramount due to the soaring value of business losses resulting from security breaches. This increase of connected assets and devices introduces a scaling problem for the enterprise which strains earlier security and compliance models and procedures.

A data breach or intrusion can result in an organization losing confidential or proprietary data, customers, revenue, reputational value, loss of operational continuity and can question the integrity of its remaining data. Such losses can range from a nuisance to irreversible. In this context, the process of onboarding a pSOC to comply with all the digital security standards of the dSOC has historically been a highly labor intensive and expensive process for system and network IT operations attempting to sort out and establish the pSOC's compliance. This stresses the human and monetary resources of both the dSOC and pSOC. This delay and expense inhibits the enterprises' ability to rapidly meet the demands of the market or the demands of time-sensitive or time-critical business manpower or operations requirements.

Although a number of processes and procedures have been employed in the past to effect onboarding, the previous methods, apparatuses and systems have lacked the technical and fiscal efficiency needed to meet the business demands of the enterprise. Solutions need to adapt to accommodate the current and future needs of the enterprise. Accordingly, it would be an improvement in the art to streamline the identification of and compliance with digital security requirements.

### SUMMARY OF THE INVENTION

The present invention relates to methods, apparatuses and systems to improve identification of digital security requirements and compliance in static or evolving digital environments. The present invention and disclosed technology provide solutions which readily adapt to accommodate the current, changing and future digital security needs of the enterprise. The present invention uses recurring monitoring and reprovisioning of the technical (hardware, software, privacy, encryption, etc.) digital security requirements and compliance. The present invention is not directed to monitoring content of business data and information passed between or to or from dSOC and pSOC over their associated devices and networks/systems to each other or to third parties. The present invention is directed to the technical, digital standards and capabilities used by dSOC and pSOC to meet the security needs of dSOC.

The present invention provides automated processes, apparatuses and systems to significantly shorten the time required to onboard pSOC to meet the business needs of dSOC by more rapidly and recurringly assessing, facilitating, deploying and/or confirming compliance with each digital security requirement of dSOC such as or related to, but not limited to, bandwidth, setups, VLANS, WANS, encryption, availability, integrity and confidentiality of all services and systems that are outsourced to third parties, configuration management, identity, credential and access management, hacking, malware, viruses, data protection, threat monitoring,

One step includes initial and, as needed, later recurring assessment and identification of the digital security requirements of the dSOC. Another step includes initial and, as needed, later recurring assessment and identification of the existing digital security capabilities of the pSOC. Another step includes identifying any gaps between the digital security requirements of the dSOC and the existing digital security capabilities of the pSOC.

The present invention examines the requirements of the dSOC and the existing device and/or network capabilities of the pSOC to identify whether the device and/or network of the pSOC is in compliance with the dSOC's digital security requirements. If so, that compliance is reported to the dSOC and the parties commence/continue onboarding digital business relations. If not, the disclosed technology identifies how or what the pSOC can or must do to comply with the dSOC's security requirements. In this way, the disclosed technology acts as a digital intersection or handshake between the dSOC security requirements and the pSOC device and/or network capabilities to facilitate pSOC compliance with the dSOC's security requirement. This is helpful when the dSOC is short-handed and/or is required to implement complex governmental regulations which may be difficult to translate into digital device/network compliance. This is also helpful when the pSOC neither understands the dSOC's security requirements nor appreciates how or what the pSOC is currently able to do or must add to comply with the dSOC's security requirements.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will follow from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings.

Understanding that the drawings depict only typical embodiments of the present invention and are not, therefore, to be considered as limiting the scope of the invention, the present invention will be described and explained with additional specificity and detail through the use of the accompanying drawings in which:

FIG. 1 depicts a schematic of the digital intersection the disclosed digital intermediary provides between the dSOC and the pSOC in accordance with a representative embodiment of the invention;

FIG. 2 depicts a schematic illustrating establishing digital security compliance between the standards of the dSOC, Sᵢ, and the capabilities of the pSOC, Cᵢ.

FIG. 3A depicts a schematic illustrating initial failure to establish digital security compliance between the standards of the dSOC, Sᵢ, and the capabilities of the pSOC, Cᵢ;

FIG. 3B depicts a schematic illustrating establishing digital security compliance between the standards of the dSOC, Sᵢ, and the capabilities Cᵢ and modified capabilities MCᵢ of the pSOC after initial failure as depicted in FIG. 3A;

FIG. 4 depicts a flowchart of identifying digital security requirements and compliance;

FIG. 5 illustrates a representative, suitable computing environments for some embodiments; and

FIG. 6 illustrates a representative, suitable computing network environment for some embodiments.

### DETAILED DESCRIPTION OF THE INVENTION

Reference throughout this specification to “one embodiment,” “an embodiment,” or similar language means that a particular feature, structure, or characteristic described m connection with the embodiment is illustrative and is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of suitable device/network, systems and methods for identifying dSOC digital security requirements and for assessing and facilitating pSOC device/network compliance. With the disclosure of the present invention, one having ordinary skill in the relevant art will recognize, that the invention may be practiced in other forms without undue experimentation and without one or more of the specific details, or with other systems, methods components, materials, and so forth. In other instances, well-known systems, structures, materials, methods, or operations known to those of skill in the art are not shown or described in detail to avoid obscuring aspects of the invention.

In the disclosure and in the claims, the term dSOC refers to distributive enterprise whose business operations, devices, network, system or data are to be digitally shared with other digital endpoints such as devices, networks, systems and the like in order to accomplish the business of the enterprise.

As used herein, the term pSOC refers to any digital endpoint of dSOC business.

The following disclosure of the present invention is grouped into two subheadings, namely “Representative Methods” and “Representative Embodiment of an Apparatus and Operating System.” The utilization of the subheadings is for convenience of the reader only and is not to be construed as limiting in any sense.

### Representative Methods

The present invention relates to methods for initial and recurring identification of and compliance with digital security standards. Many business enterprises seek to protect business data, devices, networks and systems from threat or breach. This protection may be driven by economic, quality, reliability, privacy and\or governmental regulations such as FERPA, HIPPA, SOX, FISMA, NIST, DHS, PCI DSS, ISO and the like. Often, the complexities associated with such business requirements or governmental regulations imposed on the enterprise must be translated into digital device, network or system security standards. While such business requirements and/or government regulations may or may not be fully understood by the IT personnel of the enterprise, the enterprise is nevertheless under financial or legal requirement to handle and/or protect the associated business data, devices, networks and systems. This can impose a staggering burden on enterprise IT personnel responsible to coordinate with each endpoint of the enterprise.

The endpoint/pSOC is also burdened with ensuring technical compliance. For example, if an endpoint/pSOC is a call-center employee or bank employee using voice-over-IP for phone services and Internet connection, dSOC standards may include encryption, a secured connection, a non-wireless connection to phone services, sufficient Internet bandwidth, line transmission reliability and integrity, etc. to avoid security, hacks, dropped calls, etc., all overlain with government regulations of privacy, accuracy, etc., which the endpoint/pSOC must meet. The endpoint/pSOC may or may not understand whether or how it does or can meet the security standards required by the enterprise call center or bank. The present invention provides an inventive digital intermediary between the dSOC and the pSOC to facilitate the ability of the pSOC to comply with the digital security standards of the dSOC.

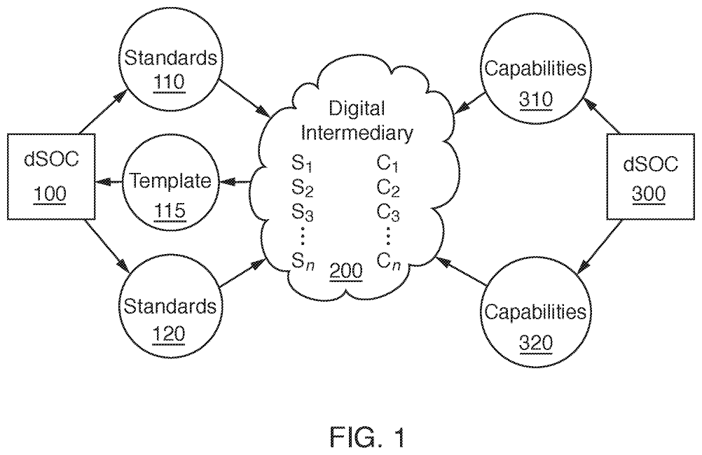

As depicted in FIG. 1, dSOC 100 communicates its digital security standards Sᵢ₋ₙ 110 to intermediary 200. Intermediary 200 analyzes standards Sᵢ₋ₙ 110 to evaluate the technical scope of each Sᵢ. In one embodiment, if dSOC 100 has not or does not fully comprehend the nature of a standard imposed upon it by, for example, a government regulation such as HIPPA or FERPA, intermediary 200 may provide dSOC 100 with a template of technical digital security mechanisms 115 known to or developed by intermediary 200 from which dSOC 100 can establish an appropriate, corresponding standard, Sᵢ 120.

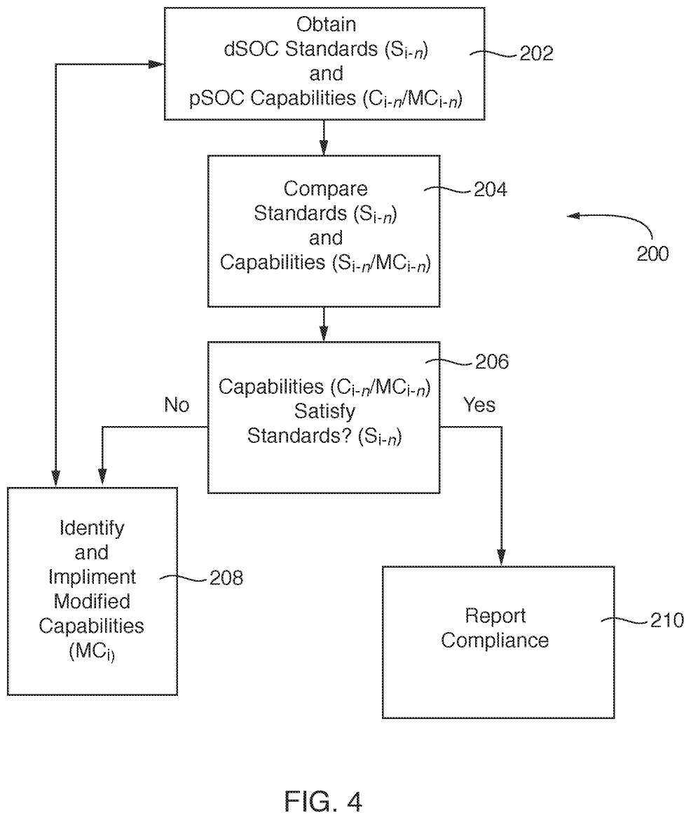

In another embodiment, standards Sᵢ₋ₙ 120 represents updated or otherwise subsequently modified digital security standards of dSOC 100 which dSOC 100 communicates to intermediary 200 as now required by dSOC 100. In another embodiment, intermediary 200 may notify dSOC 100 by a template 115 or otherwise about new hardware, software, encryption technology or changes to regulations which dSOC 100 may incorporate into its existing standards for updated or revised Sᵢ₋ₙ. These communications 110, 115 and 120 between dSOC 100 and intermediary 200 which identify the digital security standards Sᵢ₋ₙ of dSOC 100 may be accomplished digitally and are represented in FIG. 4 as steps 202 and 208 of obtaining standards Sᵢ₋ₙ of dSOC 100.

Also depicted in FIG. 1, are communications between pSOC 300 and intermediary 200. pSOC may or may not have the technical expertise or manpower to independently assess or comprehend the currently utilized or potentially utilized existing security capabilities Cᵢ of pSOC's device(s), network(s) and/or system(s). If it does, in one embodiment, pSOC 300 communicates its security capabilities Cᵢ₋ₙ 310 to intermediary 200. In another embodiment, pSOC 300 grants intermediary 200 digital access to electronically inventory the security capabilities of pSOC's device(s), network(s) and/or system(s) Cᵢ₋ₙ 310. This can be accomplished by a digital algorithm of intermediary 200 which reads the registers of pSOC's device(s), network(s) and/or system(s) and creates a list of pSOC's current, existing security capabilities Cᵢ₋ₙ. These communications 310 between pSOC 300 and intermediary 200 which identify the digital security capabilities Cᵢ₋ₙ of the device(s), network(s) and/or system(s) of pSOC 300 are represented in FIG. 4 as the step 202 of obtaining security capabilities Cᵢ₋ₙ of pSOC 300.

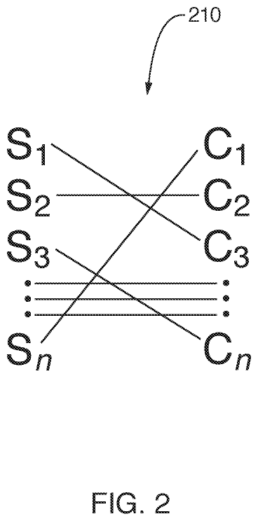

After intermediary 200 obtains an understanding of standards Sᵢ₋ₙ and Cᵢ₋ₙ, step 202 of FIG. 4, intermediary 200 applies an algorithm 204 to map a comparison or correlation between each standard Sᵢ₋ₙ and the capabilities Cᵢ₋ₙ to determine whether there is at least one satisfactory security capability Cᵢ to meet each standard Sᵢ. A successful mapping or correlation between Cᵢ₋ₙ, and Sᵢ₋ₙ is illustrated in the schematic of FIG. 2 as compliance 210. That is, for each required dSOC security standard Sᵢ there is a corresponding pSOC security capability Cᵢ. When there is successful mapping between Cᵢ₋ₙ, and Sᵢ₋ₙ, at step 206, intermediary 200 reports 210 to dSOC 100 that the device(s), network(s) and/or system(s) of pSOC 300 comply with dSOC's digital security standards.

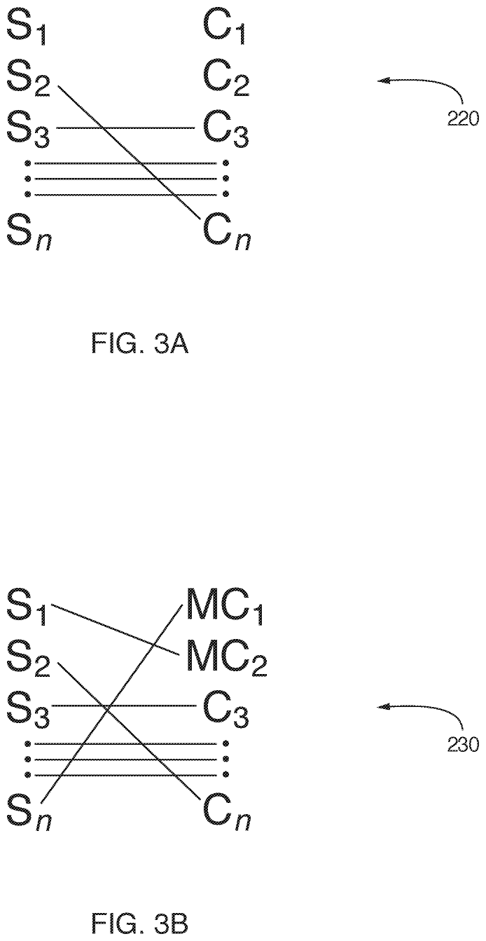

If, as depicted as 220 in FIG. 3A as to S₁ and Sₙ, when the algorithm 204 determines that there is not at least one satisfactory security capability Cᵢ to meet each standard Sᵢ, intermediary 200 reports noncompliance to pSOC and which Sᵢ standards are not yet but must be met by pSOC. In one embodiment, based upon the inventory of capabilities previously known by intermediary 200 of pSOC's security setting and capabilities, intermediary 200 identifies 208 whether existing settings such as SSDI or other security parameters of pSOC's device(s), network(s) and/or system(s) may be altered to provide modified security capabilities MCᵢ to meet any outstanding Sᵢ requirement. In another embodiment, intermediary 200, identifies 208 and reports to pSOC appropriate additional hardware, software, encryption or other modified security capabilities MCᵢ which pSOC may deploy to meet any outstanding standard(s) Sᵢ₋ₙ. In one embodiment, pSOC alters settings of existing software and/or hardware and/or procures and deploys additional hardware and/or software to provide the needed security capabilities MCᵢ to meet any outstanding Sᵢ requirements. In another embodiment, pSOC authorizes intermediary 200 to alter settings of hardware and/or software of pSOC and/or to procure and deploy additional hardware and/or software to provide modified security capabilities MCᵢ to meet any outstanding Sᵢ requirements.

Thereafter, intermediary 200 again obtains or confirms an understanding of standards Sᵢ₋ₙ 120, capabilities C/MCᵢ₋ₙ, 320, step 202 of FIG. 4. Intermediary 200 again applies the algorithm to C/MCᵢ₋ₙ to Sᵢ₋ₙ 204 to map a comparison or correlation between each standard Sᵢ₋ₙ and capabilities C/MCᵢ₋ₙ to determine whether there is at least one satisfactory security capability MCᵢ to meet each standard Sᵢ, step 206. This process of altering settings and/or procuring and deploying additional security capabilities MCᵢ is repeated until a successful mapping or correlation between C/MCᵢ₋ₙ, and Sᵢ₋ₙ is achieved as illustrated in FIG. 3B as 230. That is, for each required dSOC security standard Sᵢ there is a corresponding pSOC security capability C/MCᵢ. When there is successful mapping between C/MCᵢ₋ₙ, and Sᵢ₋ₙ intermediary 200 reports 210 to dSOC 100 that the device(s), network(s) and/or system(s) of pSOC 300 comply with dSOC's digital security standards.

In these ways, digital intermediary 200 provides an intersection where intermediary 200 confirms whether or in what manner the digital security standards established by dSOC 100 are or may be met by corresponding capabilities of pSOC 300. For example, if dSOC 100 requires pSOC 300 to use a virtual private network (VPN), digital intermediary 200 assesses whether pSOC 300 is using or employs the equivalent of a VPN. In one embodiment, intermediary 200 makes this assessment by pSOC 300 granting intermediary 200 digital access to assess the nature, settings and parameters of all devices, systems and networks of pSOC 300. In another embodiment, intermediary 200 makes this assessment by pSOC 300 providing intermediary 200 the nature, settings and parameters of all devices, systems and networks of pSOC 300. In another embodiment, intermediary 200 makes this assessment by pSOC 300 granting intermediary 200 automated and/or recurring digital access to make the assessment. Or, in another embodiment, pSOC 300 recurringly provides intermediary 200 the nature, settings and parameters of all devices, systems and networks of pSOC 300. Intermediary 200 then executes steps 202, 204, 206, 208 and/or 210 to assess, facilitate and/or confirm and report VPN and/or other required compliance between dSOC and pSOC. In each of these embodiments, intermediary 200 analyzes the existing VPN capabilities of the devices, networks and systems of pSOC 300 to assess compliance. This same procedure can be used the assess, facilitate and/or confirm compliance with each digital security requirement of dSOC.

Another example includes if dSOC 100 requires pSOC 300 to use a secure digital connection, digital intermediary 200 assesses whether pSOC 300 is using or employs the equivalent of a secured connection. In one embodiment, intermediary 200 makes this assessment by pSOC 300 granting intermediary 200 digital access to its hardware and/or software to assess the secured connectivity settings such as SSDI of all devices, systems and networks of pSOC 300. In another embodiment, intermediary 200 makes this assessment by pSOC 300 providing intermediary 200 the nature, settings and parameters of the secured connectivity all devices, systems and networks of pSOC 300. In another embodiment, intermediary 200 makes this secured connectivity assessment by pSOC 300 granting intermediary 200 automated and/or recurring digital access to it hardware and/or software. In another embodiment, pSOC 300 recurringly provides intermediary 200 the nature, settings and parameters of secured connectivity or lack thereof as to all devices, systems and networks of pSOC 300. Intermediary 200 then executes steps 202, 204, 206, 208 and/or 210 to assess, facilitate and/or confirm and report secured connectivity and/or other required compliance between dSOC and pSOC. In each of these embodiments, intermediary 200 analyzes the existing secured connectivity capabilities of the devices, networks and systems of pSOC 300 to assess compliance.

### Representative Embodiment of an Operating Environment

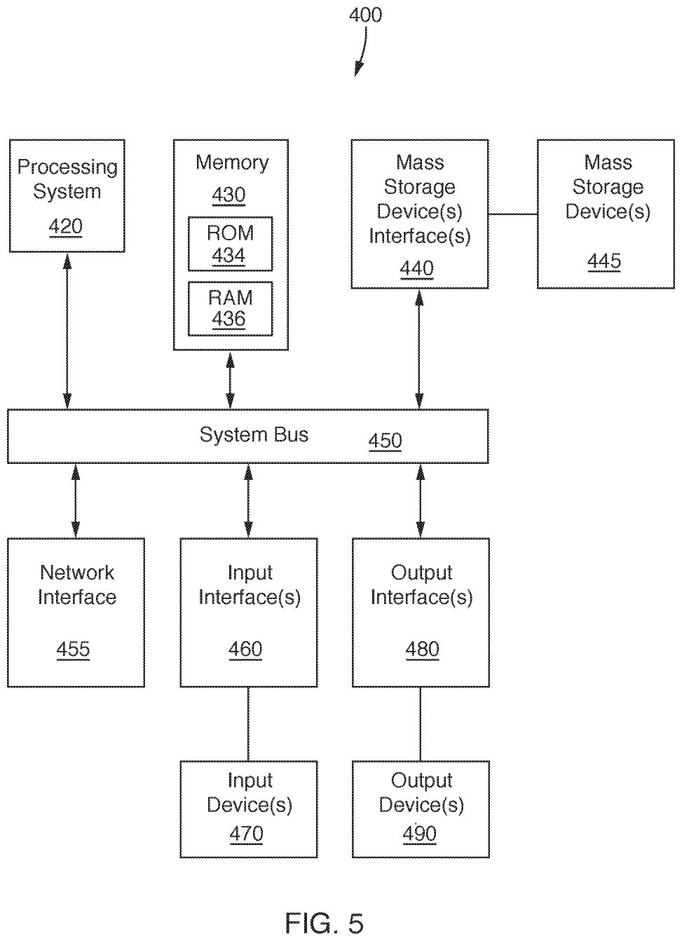

The described systems and methods can be used with or in any suitable operating environment and/or software suitable to effect steps 202, 204, 206, 208 and 210. In this regard, FIG. 5 and the corresponding discussion are intended to provide a general, illustrative description of suitable operating/computing environment(s) in which embodiments of the invention may be implemented. One skilled in the art will appreciate that embodiments of the invention may be practiced by one or more computing devices and in a variety of network and system configurations. However, while the methods and processes of the present invention are particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand-alone electronic devices, and other such electronic environments.

Some embodiments of intermediary 200 embrace one or more computer-readable media, wherein each medium may be configured to include or includes thereon data or computer executable instructions for receiving, analyzing and/or manipulating data to achieve communications 110, 115, 120, 310 and 320, steps 202, 204, 206, 208 and 210 of intermediary 200 and the procedures associated with intermediary 200 accessing and inventorying the hardware and/or software security capabilities of pSOC 300. These novel computer executable instructions include data structures, objects, programs, routines, or other program modules that may be accessed by a processing system, such as one associated with a general-purpose computer capable of performing various different functions or one associated with a special-purpose computer or associated network capable of performing a limited number of functions.

Computer executable instructions cause the processing system to perform a particular function or group of functions and are examples of program code means for implementing steps for methods disclosed herein. Furthermore, a particular sequence of the executable instructions to effect steps 202, 204, 206, 208 and 210 and communications 110, 115, 120, 310 and 320 as well as accessing and inventorying the security capabilities of the hardware and/or software of pSOC 300 by intermediary 200 provides an example of corresponding acts that may be used to implement such steps, communications and procedures. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other suitable device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 5, a representative system for implementing embodiments of the invention includes computer device 400, which may be a general-purpose or special-purpose computer or any of a variety of consumer electronic devices. For example, computer device 400 may be a desktop, client, smart phone, feature phone, handheld device, personal computer, a notebook computer, a netbook, a tablet computer such as the iPad® manufactured by Apple or any of a variety of ANDROID™-based, AMAZON®-based, BLACKBERRY®-based, WINDOWS®-based, and/or similar tablet (and/or other handheld) computers produced by multiple manufacturers, a personal digital assistant (“PDA”) or other hand-held device, a workstation, a minicomputer, a mainframe, a supercomputer, a multi-processor system, a network computer, a processor-based consumer electronic device, or the like, running with any suitable operating system (including, without limitation, iOS, Android, Windows, Linux, UNIX, Chromium OS, OS X, BSD, QNX, IBM z/OS, and/or any other suitable known and/or novel operating system).

Computer device 400 includes system bus 450, which may be configured to connect various components thereof and enables data to be exchanged between two or more components. System bus 450 may include one of a variety of bus structures including a memory bus or memory controller, a peripheral bus, or a local bus that uses any of a variety of bus architectures. Typical components connected by system bus 450 include processing system 420 and memory 430. Other components may include one or more mass storage device interfaces 440, input interfaces 460, output interfaces 480, and/or network interfaces 455, as discussed below.

Processing system 420 includes one or more processors, such as a central processor and optionally one or more other processors designed to perform a particular function or task. It is typically processing system 420 that executes the instructions provided on computer-readable media, such as on memory 430, a solid-state drive, a flash drive, a magnetic hard disk, a removable magnetic disk, a magnetic cassette, an optical disk, or from a communication connection, which may also be viewed as a computer-readable medium.

Memory 430 includes one or more computer-readable media that may be configured to include or includes thereon data or instructions for manipulating data, and may be accessed by processing system 420 through system bus 450. Memory 430 may include, for example, ROM 434, used to permanently store information, and/or RAM 436, used to temporarily store information. ROM 434 may include a basic input/output system (“BIOS”) having one or more routines that are used to establish communication, such as during start-up of computer device 400. RAM 436 may include one or more program modules, such as one or more operating systems, application programs, and/or program data.

One or more mass storage device interfaces 440 may be used to connect one or more mass storage devices 445 to system bus 450. The mass storage devices 445 may be incorporated into or may be peripheral to computer device 400 and allow computer device 400 to retain large amounts of data. Optionally, one or more of the mass storage devices 445 may be removable from computer device 400. Examples of mass storage devices include solid-state drives, flash drives, hard disk drives, magnetic disk drives, tape drives and optical disk drives. A mass storage device 445 may read from and/or write to a magnetic hard disk, a removable magnetic disk, a magnetic cassette, an optical disk, or another computer-readable medium. Mass storage devices 445 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 460 may be employed to enable a user to enter data and/or instructions to computer device 400 through one or more corresponding input devices 470. Examples of such input devices 470 include a keyboard and alternate input devices, such as a mouse, trackball, touch screen, light pen, stylus, or other pointing device, a microphone, a joystick, a game pad, a satellite dish, a scanner, a camcorder, a digital camera, and the like. Similarly, examples of input interfaces 460 that may be used to connect the input devices 470 to the system bus 450 include a serial port, a parallel port, a game port, a universal serial bus (“USB”), an integrated circuit, a FIREWIRE® (IEEE 1394), lightning port, HDMI, or another interface. For example, in some embodiments input interface 460 includes an application specific integrated circuit (ASIC) that is designed for a particular application. In a further embodiment, the ASIC is embedded and connects existing circuit building blocks.

One or more output interfaces 480 may be employed to connect one or more corresponding output devices 490 to system bus 450. Examples of output devices include a monitor or display screen or other electronic display, a speaker, a printer, a multi-functional peripheral, and the like. A particular output device 490 may be integrated with or peripheral to computer device 400. Examples of output interfaces include a video adapter, an audio adapter, a parallel port, and the like. Examples of electronic displays include monitors, televisions, e-ink displays, projection displays, or any other display capable of displaying changing information under the control of a computer device.

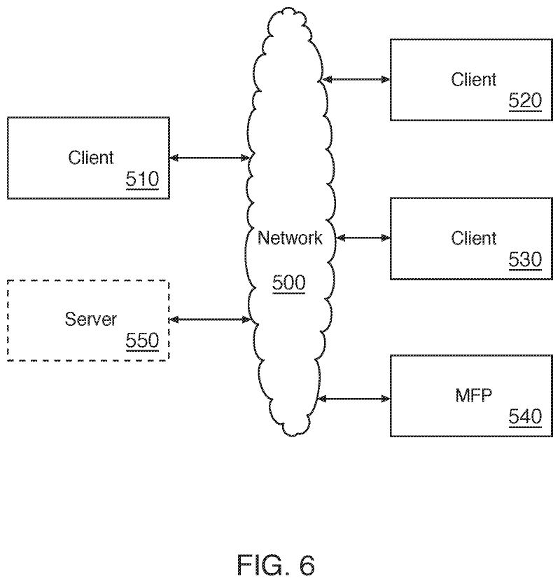

One or more network interface(s) 455 enable computer device 400 to exchange information with one or more other local or remote computer devices via a network 500, FIG. 6, that may include hardwired and/or wireless links. Examples of network interfaces include a network adapter for connection to a local area network (“LAN”) or a modem, wireless link, or other adapter for connection to a wide area network (“WAN”), such as the Internet. The network interface may be incorporated with or peripheral to computer device 400. In a networked system, accessible program modules or portions thereof may be stored in a remote memory storage device. Furthermore, in a networked system computer device 400 may participate in a distributed computing environment, such as a cloud-based computer environment, where functions or tasks are performed by a plurality of networked computer devices.

Thus, while those skilled in the art will appreciate that embodiments of the present invention may be practiced in a variety of different environments with many types of system configurations. FIG. 6 provides a representative networked system configuration that may be used in association with embodiments of the present invention. The representative system of FIG. 6 includes a computer device, illustrated as client 510, which is connected to one or more other computer devices (illustrated as client 520 and client 530) and one or more peripheral devices (illustrated as multifunctional peripheral (MFP) 540 across network 500. While FIG. 6 illustrates an embodiment that includes a client 510, two additional clients, client 520 and client 530, one peripheral device, MFP 540, and optionally a server 550, which may be a print server, connected to network 500, alternative embodiments include more or fewer clients, more than one peripheral device, no peripheral devices, no server 550, and/or more than one server 550 connected to network 500. These devices are chosen to meet the onboarding needs between dSOC and pSOC. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet. Similarly, embodiments of the invention embrace cloud-based architectures where one or more computer functions are performed by remote computer systems and devices at the request of a local computer device. Thus, returning to FIG. 6, the client 510 may be a computer device having a limited set of hardware and/or software resources related to digital security capabilities Cᵢ₋ₙ. Because the client/pSOC 510 is connected to the network 500 of dSOC, it may be able to access hardware and/or software resources provided across the network 500 by other computer devices and resources, such as client 520, client 530, server 550, or any other resources. The client/pSOC 510 may access these resources through an access program, such as a web browser, and the results of any computer functions or resources may be delivered through the access program to the user of the client 510. In such configurations, the client 510 may be any type of computer device or electronic device discussed above or known to the world of cloud computing (e.g., a platform-as-a-service, a software-as-a-service technique, an application programming interface, and/or otherwise), including traditional desktop and laptop computers, smart phones, and other smart devices, tablet computers, or any other device able to provide access to remote computing resources through an access program, such as a browser. Accordingly, in some embodiments, the described systems and methods can allow an enterprise/dSOC to rapidly onboard the digital device(s), network(s) and/or system(s) of a needed third-party/employee/pSOC while ensuring that the digital security capabilities of the third-party/employee/pSOC comply with the digital security standards of the enterprise dSOC.

Thus, as discussed herein, the embodiments of the present invention embrace apparatus/computer programs, systems and methods for requiring digital security standard compliance between connected or associated devices, networks and/or systems.

The present invention may be embodied in other specific forms without departing from its spirit or essential characteristics. The described embodiments are to be considered in all 5 respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer program product for negotiating digital security standards and compliance between associated computing devices of a distributive security operation center and a personal security operation center, the computer program product comprising:
a computer-readable, non-transitory medium for providing computer program code wherein the computer program code comprises executable code for implementing steps for:
obtaining the existing digital security capabilities of a personal security operation center;
obtaining the required digital security standards of a distributive security operation center, each of the standards have specified technical functionality;
electronically comparing the existing digital security capabilities of the personal security operation center with the required digital security standards of the distributive security operation center; and
electronically determining whether at least one existing digital security capability of the personal security operation center satisfies the technical functionality of each of the required digital security standards of the distributive security operation center.

2. The computer program product of claim 1, further comprising executable code for implementing the step of reporting to the distributive security operation center and the personal security operation center whether each required digital security standard is satisfied by at least one existing digital security capability.

3. The computer program product of claim 1, wherein obtaining the existing digital security capabilities of a personal security operation center is accomplished by electronically accessing and reviewing of the digital registers of the computing device(s) of the personal security operation center.

4. The computer program product of claim 1, further comprising executable code for implementing the step of identifying the technical functionality of the required digital security standards of the distributive security operation center not satisfied by at least one digital security capability of the personal security operation center and presenting to the personal security operations center a template of alterable device settings of the computing device(s) of the personal security operation center to provide the technical functionality needed to satisfy the digital security standards of the distributive security operation center not satisfied by at least one existing digital security capability of the personal security operation center.

5. The computer program product of claim 4, further comprising executable code for implementing the step of electronically altering device settings of the computing device(s) of the personal security operation center to provide the technical functionality needed to satisfy the digital security standards of the distributive security operation center not satisfied by at least one existing digital security capability of the personal security operation center.

6. The computer program product of claim 1, further comprising executable code for implementing the step of identifying the technical functionality of the required digital security standards of the distributive security operation center not satisfied by at least one digital security capability of the personal security operation center and presenting to the personal security operations center a template of additional hardware and/or software providing the technical functionality to satisfy the digital security standards of the distributive security operation center not satisfied by at least one existing digital security capability of the personal security operation center.

7. The computer program product of claim 6, further comprising executable code for implementing the step of electronically downloading additional software to the device(s) of the personal security operation center to provide the technical functionality needed to satisfy the digital security standards of the distributive security operation center not satisfied by at least one existing digital security capability of the personal security operation center.

8. A method for negotiating digital security standards and compliance between associated computing devices of a distributive security operation center and a personal security operation center, the method comprising the steps of :
electronically transmitting and storing in electronic media on a computing device of an intermediary the existing digital security capabilities of a personal security operation center;
electronically transmitting and storing in electronic media on a computing device of an intermediary the required digital security standards of a distributive security operation center, each of the standards have specified technical functionality;
electronically comparing by the computing device of an intermediary the existing digital security capabilities of the personal security operation center with the required digital security standards of the distributive security operation center; and
electronically determining by the computing device of an intermediary whether at least one existing digital security capability of the personal security operation center satisfies the technical functionality of each of the required digital security standards of the distributive security operation center.

9. The method of claim 8, further comprising the step of reporting to the distributive security operation center and the personal security operation center whether each required digital security standard is satisfied by at least one existing digital security capability.

10. The method of claim 8, wherein obtaining the existing digital security capabilities of a personal security operation center is accomplished by the computing device of an intermediary electronically accessing and reviewing of the digital registers of the computing device(s) of the personal security operation center.

11. The method of claim 8, further comprising the step of identifying by the computing device of an intermediary the technical functionality of the required digital security standards of the distributive security operation center not satisfied by at least one digital security capability of the personal security operation center and presenting by the computing device of an intermediary to the personal security operations center a template of alterable device settings of the computing device(s) of the personal security operation center to provide the technical functionality needed to satisfy the digital security standards of the distributive security operation center not satisfied by at least one existing digital security capability of the personal security operation center.

12. The method of claim 11, further comprising the step of electronically altering by the computing device of an intermediary device settings of the computing device(s) of the personal security operation center to provide the technical functionality needed to satisfy the digital security standards of the distributive security operation center not satisfied by at least one existing digital security capability of the personal security operation center.

13. The method of claim 8, further comprising the step of identifying by the computing device of an intermediary the technical functionality of the required digital security standards of the distributive security operation center not satisfied by at least one digital security capability of the personal security operation center and presenting by the computing device of an intermediary to the personal security operations center a template of additional hardware and/or software providing the technical functionality to satisfy the digital security standards of the distributive security operation center not satisfied by at least one existing digital security capability of the personal security operation center.

14. The method of claim 13, further comprising the step of electronically downloading by the computing device of an intermediary additional software to the device(s) of the personal security operation center to provide the technical functionality needed to satisfy the digital security standards of the distributive security operation center not satisfied by at least one existing digital security capability of the personal security operation center.

15. A system for negotiating digital security standards and compliance between associated computing devices of a distributive security operation center and a personal security operation center, the system comprising:
a computing device or network used by a distributive security operation center having required digital security standards;
a computing device or network used by a personal security operation center having existing digital security capabilities;
a computing device or network used by an intermediary, the computing device used by an intermediary comprising computer-readable, non-transitory medium for providing computer program code wherein the computer program code comprises executable code for implementing steps for:
obtaining the existing digital security capabilities of a personal security operation center;
obtaining the required digital security standards of a distributive security operation center, each of the standards have specified technical functionality;
electronically comparing the existing digital security capabilities of the personal security operation center with the required digital security standards of the distributive security operation center; and
electronically determining whether at least one existing digital security capability of the personal security operation center satisfies the technical functionality of each of the required digital security standards of the distributive security operation center.

16. The system of claim 15, the computer program further comprising executable code for implementing the step of reporting to the distributive security operation center and the personal security operation center whether each required digital security standard is satisfied by at least one existing digital security capability.

17. The system of claim 15, wherein obtaining the existing digital security capabilities of a personal security operation center is accomplished by electronically accessing and reviewing of the digital registers of the computing device(s) of the personal security operation center.

18. The system of claim 15, the computer program further comprising executable code for implementing the step of identifying the technical functionality of the required digital security standards of the distributive security operation center not satisfied by at least one digital security capability of the personal security operation center and presenting to the personal security operations center a template of alterable device settings of the computing device(s) of the personal security operation center to provide the technical functionality needed to satisfy the digital security standards of the distributive security operation center not satisfied by at least one existing digital security capability of the personal security operation center.

19. The system of claim 18, the computer program further comprising executable code for implementing the step of electronically altering device settings of the computing device(s) of the personal security operation center to provide the technical functionality needed to satisfy the digital security standards of the distributive security operation center not satisfied by at least one existing digital security capability of the personal security operation center.

20. The system of claim 15, the computer program further comprising executable code for implementing the step of identifying the technical functionality of the required digital security standards of the distributive security operation center not satisfied by at least one digital security capability of the personal security operation center and presenting to the personal security operations center a template of additional hardware and/or software providing the technical functionality to satisfy the digital security standards of the distributive security operation center not satisfied by at least one existing digital security capability of the personal security operation center.

21. The system of claim 20, the computer program further comprising executable code for implementing the step of electronically downloading additional software to the device(s) of the personal security operation center to provide the technical functionality needed to satisfy the digital security standards of the distributive security operation center not satisfied by at least one existing digital security capability of the personal security operation center.
